(19) United States
(12) Patent Application Publication
(10) Pub. No.: US 2014/0324487 A1
(43) Pub. Date: Oct. 30, 2014

(54) METHOD, APPARATUS, AND SYSTEM FOR BUSINESS PROCESSING

(71) Applicant: Tencent Technology (Shenzhen) Company Limited, Shenzhen (CN)

(72) Inventors: JUBO MO, Shenzhen (CN); MING ZENG, Shenzhen (CN); LIQUN ZHU, Shenzhen (CN)

(73) Assignee: Tencent Technology (Shenzhen) Company Limited, Shenzhen (CN)

(21) Appl. No.: 14/087,181

(22) Filed: Nov. 22, 2013

Related U.S. Application Data
(63) Continuation of application No. PCT/CN2013/076430, filed on May 29, 2013.

(30) Foreign Application Priority Data
Apr. 28, 2013 (CN) 201310156488.2

(51) Int. Cl. G06Q 10/02; H04W 4/12

(52) U.S. Cl. CPC G06Q 10/02; H04W 4/12
USPC 705/5

(57) ABSTRACT

Various embodiments provide methods, apparatus, and systems for business processing. An exemplary business processing method for a user terminal can be performed by establishing a connection between the user terminal and a first server for providing a third-party service via a second server for providing a public service. A business processing request can be obtained by the user terminal, which can then send the business processing request to the first server for providing the third party service via the second server for providing the public service. The first server for providing the third party service can include a business system server. Corresponding to the business processing request, the user terminal can receive a business processing response returned from the first server for providing the third-party service and forwarded by the second server for providing the public service.

### CROSS-REFERENCES TO RELATED APPLICATIONS

This application is a continuation of PCT Patent Application No. PCT/CN2013/076430, filed on May 29, 2013, which claims priority to Chinese Patent Application No. CN 201310156488.2, filed on Apr. 28, 2013, the entire content of all of which are incorporated herein by reference.

### FIELD OF THE DISCLOSURE

The present disclosure relates to the field of information processing technology and, more particularly, relates to methods, apparatus, and systems for business processing.

### BACKGROUND

With development of service industries, more business is provided to users with delicate services. Business that needs to be processed in life and at work tends to be more complex. Such business may include those regarding tickets reserving, recharging, inquiring, membership, etc. With increasing amount and complexity of the business to be processed, time required for processing the business increases. For users' convenience, related service departments need to provide the users with convenient and effective methods for processing the business to increase degree of convenience, to shorten the processing time and to improve efficiency and service quality. As such, methods for processing business are key factors for providing fast, convenient, safe, real-time services and for improving efficiency of business processing.

Currently, methods for processing include: (1) processing business at the counter, for example, the user may visit the counter in a business processing hall of a corresponding service department; (2) processing business online, the user may go online using a user management website of a corresponding service department to process business online; and (3) processing business through Short Message Service (SMS) to intact with a corresponding service department.

However, processing business at the counter requires the users to queue at the counter, which restricts the location for the users to process the business. For processing business online, although the business location is not restricted, processing business online requires additional conditions such as a communication network and Internet devices such as computers.

Mobile phones have become a popular communication tool for processing business using SMS, which is not restricted to business locations or additional conditions for processing business. However, processing business on mobile phones only uses SMS text messages to interact with related service departments. In a case when SMS text messages are used to process transportation business, e.g., for selecting seats, the text messages cannot directly show such transportation business including a seat map. This increases communication barriers in processing the business and reduces degree of convenience for users to process the business.

### BRIEF SUMMARY OF THE DISCLOSURE

According to various embodiments, there is provided a business processing method for a user terminal by first establishing a connection between the user terminal and a first server for providing a third-party service via a second server for providing a public service. A business processing request can be obtained by the user terminal, which can then send the business processing request to the first server for providing the third party service via the second server for providing the public service. The first server for providing the third party service can include a business system server. Corresponding to the business processing request, the user terminal can receive a business processing response returned from the first server for providing the third-party service and forwarded by the second server for providing the public service.

According to various embodiments, there is also provided a business processing method for a server for providing a third party service by establishing a connection between a first server for providing the third party service and a user terminal for a business processing via a second server for providing a public service. The first server for providing the third party service can receive a business processing request sent from the user terminal and forwarded by the second server for providing the public service. According to the business processing request, the first server for providing the third party service can obtain a business processing response corresponding to the business processing request and return the business processing response to the user terminal via the second server for providing the public service.

According to various embodiments, there is further provided a user terminal for business processing. The user terminal can include a first establishing module, a first obtaining module, a sending module, and a receiving module. The first establishing module can be configured to establish a connection between the user terminal and a first server for providing a third party service via a second server for providing a public service. The first obtaining module can be configured to obtain a business processing request. The sending module can be configured to send the business processing request to the first server for providing the third party service via the second server for providing the public service. The receiving module can be configured to receive a business processing response returned from the first server for providing the third party service and forwarded by the second server for providing the public service according to the business processing request.

According to various embodiments, there is further provided a server for providing a third party service. The server can include a first establishing module, a receiving module, a first obtaining module, and a returning module. The first establishing module can be configured to establish a connection between the server for providing the third party service and a user terminal for a business processing via a server for providing a public service. The receiving module can be configured to receive a business processing request sent from the user terminal and forwarded by the server for providing the public service. The first obtaining module can be configured to obtain a business processing response according to the business processing request. The returning module can be configured to return the business processing response corresponding to the business processing request to the user terminal via the server for providing the public service.

An exemplary system for business processing can include a first server for providing a third party service, a user terminal, and/or a second server for providing a public service. The second server for providing a public service can be configured to forward information between the user terminal and the first server for providing the third party service.

As disclosed herein, by establishing a connection between a first server for providing a third party service (e.g., a business system) and a second server for providing a public service (e.g., a public service platform), the second server for providing the public service can connect a user terminal with the first server for providing the third party service (e.g., the business system) such that information exchange can be performed between the user terminal and the first server for providing the third party service (e.g., the business system). This enhances convenience, mobility, and real-time operability of the business processing with improved efficiency.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the disclosure.

FIG. 1 depicts an exemplary method for business processing in accordance with various disclosed embodiments;

FIG. 2 depicts another exemplary method for business processing in accordance with various disclosed embodiments;

FIG. 3 depicts another exemplary method for business processing in accordance with various disclosed embodiments;

FIG. 4 depicts an exemplary method for information exchange during a business processing in accordance with various disclosed embodiments;

FIG. 5 depicts another exemplary method for information exchange during a business processing in accordance with various disclosed embodiments;

FIG. 6 depicts an exemplary terminal for business processing in accordance with various disclosed embodiments;

FIG. 7 depicts another exemplary terminal for business processing in accordance with various disclosed embodiments;

FIG. 8 depicts another exemplary terminal for business processing in accordance with various disclosed embodiments;

FIG. 9 depicts another exemplary terminal for business processing in accordance with various disclosed embodiments;

FIG. 10 depicts an exemplary third party service provider for business processing in accordance with various disclosed embodiments;

FIG. 11 depicts another exemplary third party service provider for business processing in accordance with various disclosed embodiments;

FIG. 12 depicts an exemplary obtaining module for business processing in accordance with various disclosed embodiments;

FIG. 13 depicts an exemplary system for business processing in accordance with various disclosed embodiments; and

FIG. 14 depicts another exemplary terminal for business processing in accordance with various disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

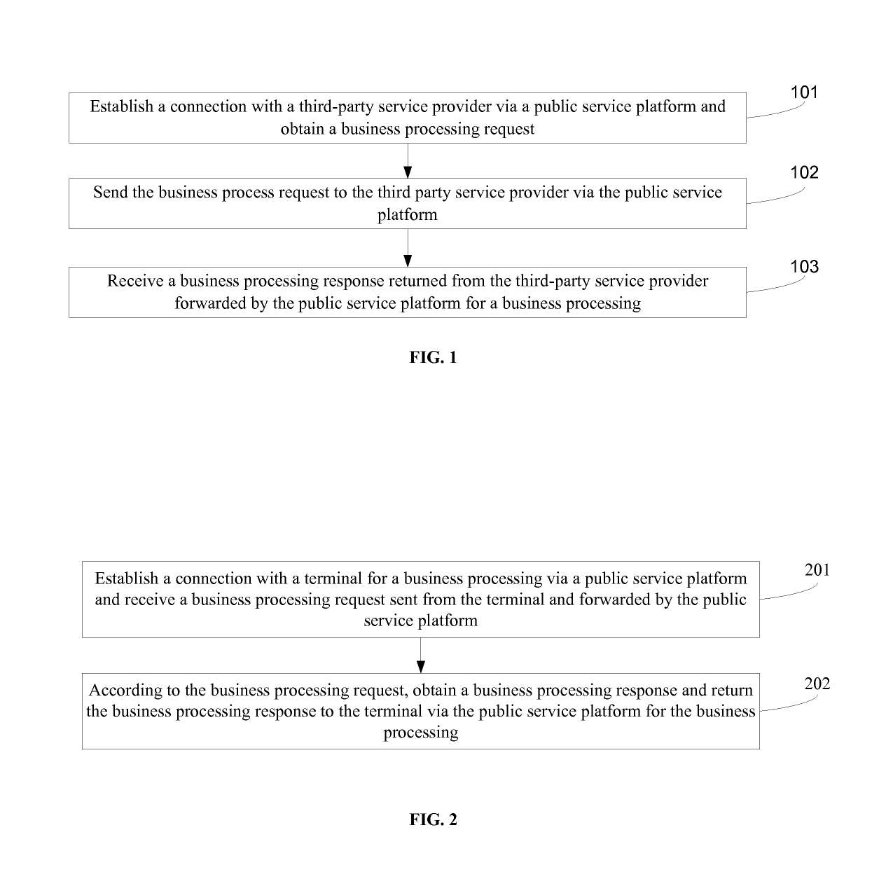

FIG. 1 depicts an exemplary method for business processing in accordance with various disclosed embodiments. In Step 101, a connection is established with a third-party service provider through a public service platform and a business processing request is obtained. In Step 102, the business processing request is sent to the third party service provider through the public service platform. In Step 103, a business processing response returned from the third-party service provider and forwarded by the public service platform is received for a business processing or to complete a business processing.

In various embodiments, a “third-party service provider” may refer to a “server (e.g., a first server) for providing a third-party service” and both terms can be interchangeably used herein. A “public service platform” may refer to a “server (e.g., a second server) for providing a public service” and both terms can be interchangeably used herein. In an exemplary embodiment, the business processing method depicted in FIG. 1 can be provided for a terminal. The term “terminal” may refer to a “user terminal”, and both terms can be interchangeably used herein.

An exemplary business processing method provided for a user terminal can include first establishing a connection between the user terminal and a first server for providing a third-party service via a second server for providing a public service. A business processing request can be obtained by the user terminal, which can then send the business processing request to the first server for providing the third party service via the second server for providing the public service. The first server for providing the third party service can include a business system server. The user terminal can receive a business processing response returned from the first server for providing the third-party service and forwarded by the second server for providing the public service corresponding to the business processing request.

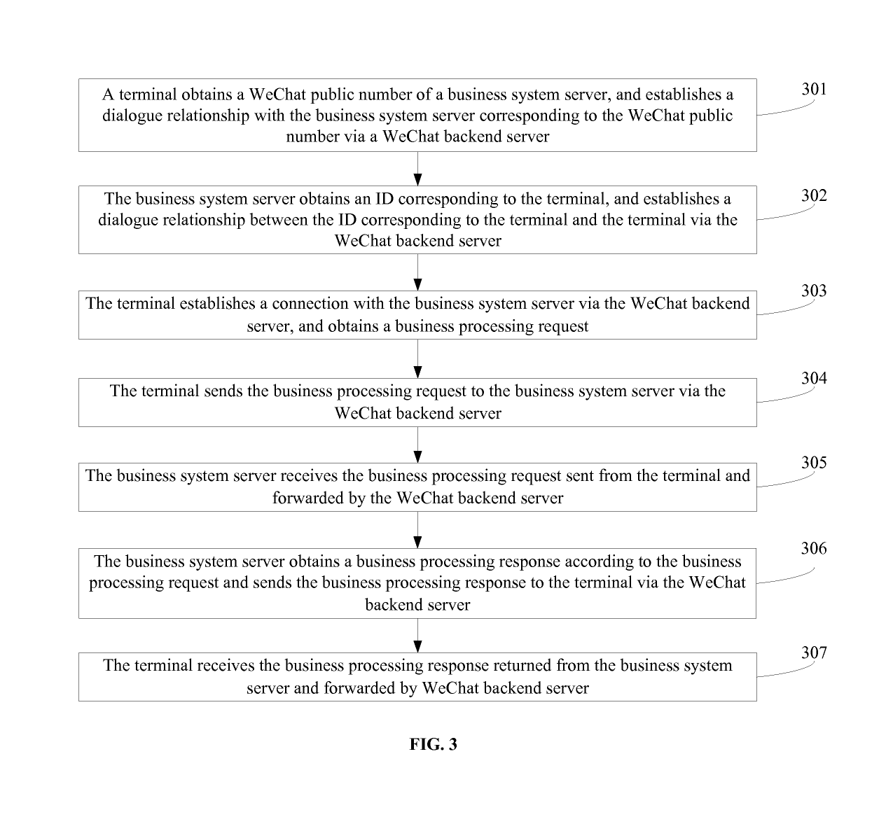

FIG. 2 depicts another exemplary method for business processing in accordance with various disclosed embodiments. In Step 201, a connection is established with a terminal for a business processing through a public service platform. A business processing request sent from the terminal and forwarded by the public service platform is received. In Step 202, according to the business processing request, a corresponding business processing response is obtained and returned to the terminal via the public service platform for the business processing or to complete the business processing.

In the methods disclosed herein, a connection between the terminal and the third-party service provider (e.g., a business system) can be established through the public service platform for information exchange, thereby enhancing convenience, mobility, and real-time operability for the business processing with improved efficiency.

For illustration purposes, methods for business processing are described herein using WeChat backend server as an exemplary public service platform and using a business system server as an exemplary third-party service provider. A public number of the third-party service provider can be a WeChat public number. In this example, user 1 may use WeChat to process boarding pass business in a business for airline check-in.

In Step 301, a terminal obtains a WeChat public number of a business system server, and establishes a dialogue relationship with the business system server corresponding to the WeChat public number through a WeChat backend server.

Any suitable methods can be used for the terminal to obtain the WeChat public number of the business system server without limitation. For example, the WeChat public number of the business system server can be obtained from newspapers, magazines, flyers, and/or other promotional materials. Alternatively, the WeChat public number of the business system server can be obtained from office lobby of a service department, an official website, a microblog, and/or other official news release. Further, the WeChat public number of the business system server can be obtained from friend(s).

In addition, any forms for obtaining the WeChat public number of the business system server can be used herein without limitation. For example, the WeChat public number of the business system server can be obtained as a 2-D (two dimensional) code or as a string of numbers.

Further, any suitable methods and forms can be used for a terminal to establish a dialogue relationship with the business system server corresponding to the WeChat public number through the WeChat backend server without limitation. For example, the dialogue relationship with the business system server corresponding to the WeChat public number can be established in a manner of using WeChat to follow a Chat public number. Alternatively, the dialogue relationship with the business system server corresponding to the WeChat public number can be established in a manner of using WeChat to add the WeChat public number from a friend.

Specifically, user 1 can obtain public number 1 as the WeChat public number of the business system server of an airline A from an official website of airline A. By following the public number 1, a dialogue relationship can be established with the business system server of airline A.

It should be noted that the terminal described herein can establish a connection with the business system server via the WeChat backend server, and establish both dialogue relationship and information exchange via establishing connection between a WeChat number corresponding to the terminal and the WeChat public number corresponding to the business system server.

That is, the terminal can send information used to establish the connection, and to establish the dialogue relationship and the information exchange to the WeChat public number through the corresponding WeChat number. The WeChat backend server can then forward the information received by the WeChat public number to the business system server. Likewise, the business system server can send information to the WeChat backend server, and then the WeChat backend server can forward the information to the WeChat number of the terminal through the WeChat public number. The terminal can receive messages sent from the business system server number via the WeChat number, such that the terminal can establish the connection with business system server via the WeChat backend server, and establish the dialogue relationship and information exchange.

In Step 302, the business system server obtains an ID corresponding to the terminal (i.e., terminal ID), and establishes a dialogue relationship between the terminal ID and the terminal via the WeChat backend server.

Any suitable methods/manners can be used for the business system server to obtain the terminal ID without any limitation. For example, the terminal ID can be obtained by obtaining a number of a followed fan or by obtaining a number of a friend in the list of friends.

Any suitable forms can be used for the business system server to obtain the terminal ID without any limitation. For example, the obtained terminal ID can be a string of numbers, an e-mail name, etc. Regardless of the form of the terminal ID, the terminal ID and information used for a user to login the WeChat backend server can be bound with each other. For example, the user may login WeChat backend server using information of the user's WeChat number, then the user's WeChat number and the terminal ID are bound with each other.

Further, any suitable forms can be used for the business system server to establish the dialogue relationship between the terminal and the terminal ID via the WeChat backend server without limitation. For example, after the business system server send the terminal ID to the WeChat backend server, the WeChat backend server can find user's WeChat number via the terminal ID. The dialogue relationship between the user's WeChat number and WeChat public number corresponding to the business system server can then be established.

Specifically, after step 301, the airline A can obtain an ID bound with WeChat number of user 1 via obtaining the number of a followed fan, and send the ID to the WeChat backend server via the business system server of the airline A. The WeChat backend server can then find WeChat number 1 corresponding to this ID. Dialogue relationship between the WeChat number 1 and the WeChat public number corresponding to the business system server can then be established.

It should be noted that, Steps 301 and 302 are not necessarily to be performed each time according to various embodiments. For example, Steps 301 and 302 can be used to establish the dialogue relationship at the first time for a user to establish the dialogue relationship with the business system server. Once such dialogue relationship is established, such dialogue relationship can be directly used for next time or in a subsequent business processing without performing Steps 301 and 302. However, when the WeChat public number of the business system server changes, the dialogue relationship with the business system server needs to be re-established and Steps 301 and 302 may need to be re-performed. According to various embodiments, conditions for re-performing Steps 301 and 302 are not limited.

In Step 303, the terminal establishes a connection with the business system server via the WeChat backend server, and obtains a business processing request.

In various embodiments, any suitable content can be included without limitation in a request message for establishing a connection sent from the terminal to the WeChat number. For example, the content of the request message for establishing the connection (also referred to as a connection request message) can include any content, which may or may not relate to current business processing.

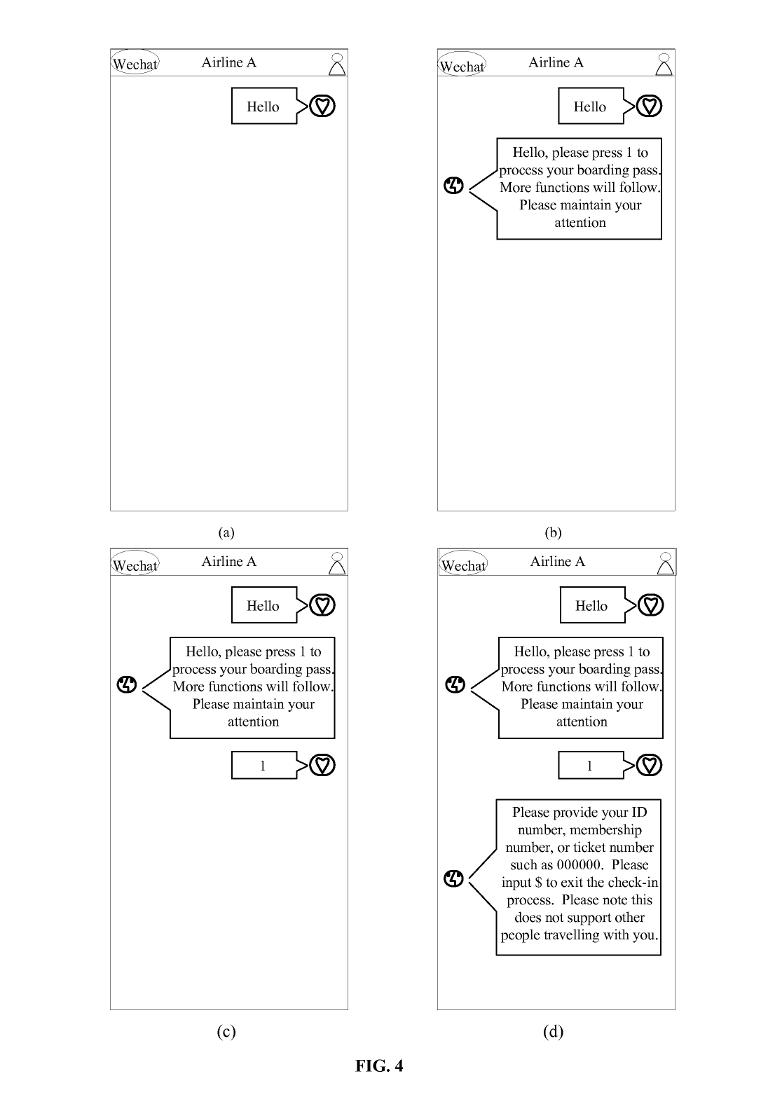

Specifically, after the user 1 sends a request message for establishing a connection as shown in FIG. 4(A) to the public number 1, the WeChat backend server of the public number 1 may forward the request message for establishing the connection, sent from the terminal, to the business system server of airline A.

In addition, after the business system server receives the request message for establishing the connection sent from the terminal, the business system server may send a response message for establishing the connection to the terminal via the WeChat backend server to establish the connection. In various embodiments, any suitable content can be included without limitation in the response message for establishing the connection (or a connection response message) sent from the business system server to the terminal. For example, the content of a connection response message can include content for guiding the terminal for processing the business.

Specifically, after the user 1 sends the connection request message as shown in FIG. 4(a) to the public number 1, a connection response message as shown in FIG. 4(b) can be received from the business system server of airline A to user 1 via the WeChat backend server.

Further, any suitable forms/manners can be used for the terminal to obtain the business processing request without limitation. For example, the business processing request obtained by the terminal may include a paragraph of text for the business processing request inputted by a user based on a guide to establishing the connection response message sent by the business system server. Alternatively, the business processing request obtained by the terminal may include a voice message for the business processing request recorded by user based on a guide to establishing the connection response message sent by the business system server.

In Step 304: the terminal sends the business processing request to the business system server via the WeChat backend server.

Any suitable forms/manners for sending the business processing request to the business system server via the WeChat backend server can be used without limitation. For example, if the business processing request obtained by the terminal in Step 303 is a paragraph of text for the business processing request inputted by a user, such paragraph of text can be sent to the business system server via the WeChat backend server. In some cases, if the business processing request obtained by the terminal in Step 303 is a voice message for the business processing request recorded by a user, such voice message can be sent to the business system server via the WeChat backend server.

In addition, after the terminal sends the business processing request to the business system server via the WeChat backend server, content (or request content) corresponding to the business processing request can be displayed on an interface of the terminal. For example, if the business processing request obtained by the terminal in Step 303 is a paragraph of text for the business processing request inputted by a user, such paragraph of text can be directly displayed on the terminal. In some cases, if the business processing request obtained by the terminal in Step 303 is a voice message for the business processing request recorded by a user, such voice message can be converted into a paragraph of text by the terminal and then displayed. Any other suitable manners/methods can be used for the terminal to display content corresponding to the business processing request without limitation.

Specifically, after performing Step 303, the terminal can obtain the business processing request inputted based on the guide to establishing the connection response message sent by the business system server. The terminal can send the business processing request to the business system server via the WeChat backend server of airline A and display the content as shown in FIG. 4(c) on a display interface of the terminal.

In Step 305, the business system server receives the business processing request sent from the terminal and forwarded by the WeChat backend server.

Any suitable manners/methods can be used for the business system server to receive the business processing request sent from the terminal and forwarded by the WeChat backend server without limitation. For example, the received business processing request can include text inputted by users or a voice message recorded by users or any other suitable content.

In Step 306, the business system server obtains a business processing response based on the business processing request and sends the business processing response to the terminal via the WeChat backend server.

For example, the business system server may first extract content or request content corresponding to the business processing request, and according to the content corresponding to the business processing request determine corresponding content (or response content) to respond, which produces the business processing response. The business processing response can then be returned to the terminal via the WeChat backend server.

Any suitable manners/methods can be used for the business system server to extract content corresponding to the business processing request without limitation. For example, if the business processing request received by the business system server includes text inputted by a user, the received text can be used in the content corresponding to the business processing request. In some cases, if the business processing request received by the business system server includes a voice message recorded by a user, the recorded voice message can first be converted into text and the text can be used in the content corresponding to the business processing request.

Further, any suitable manners/methods, without limitation, can be used to determine corresponding content in response to the business processing request. For example, the obtained content corresponding to the business processing request can be matched with response content from response content database of the business system server to determine the corresponding response content. The response content database of the business system server can store business content that the business system server may be used to respond. Any suitable manners/methods, without limitation, can be used to construct the response content database. In practice, the response content database can be constructed by, e.g., adding response content and steps for performing the response content.

For example, the business system server of airline A can receive the business processing request sent by user 1 in Step 304, and can determine that the response content corresponding to the business processing request is “boarding pass”. In addition, any suitable content can be included in the business processing response generated according to the response content without limitation. Such content may include, but be not limited to, messages generated to guide the user to process the business.

In Step 307, the terminal receives the business processing response returned from the business system server and forwarded by WeChat backend server.

For example, after the terminal receives the business processing response returned from the business system server and forwarded by WeChat backend server, the terminal can display the content corresponding to the business processing response on the display interface of the terminal. Specifically, the terminal of user 1 can receive the business processing response forwarded by WeChat backend server and generated by the business system server of airline A according to “processing the boarding pass”. The business processing response can be displayed on the interface of the terminal as shown in FIG. 4(d).

It should be noted that, Steps 304 to 307 can be repeatedly performed for the business processing according to various embodiments. For example, after performing Steps 304 to 307 for a first time and if there is a need to continue information exchange with the business system server according to the guide of the business system server, Steps 304 to 307 can be repeatedly performed for the information exchange until the user completes the business processing.

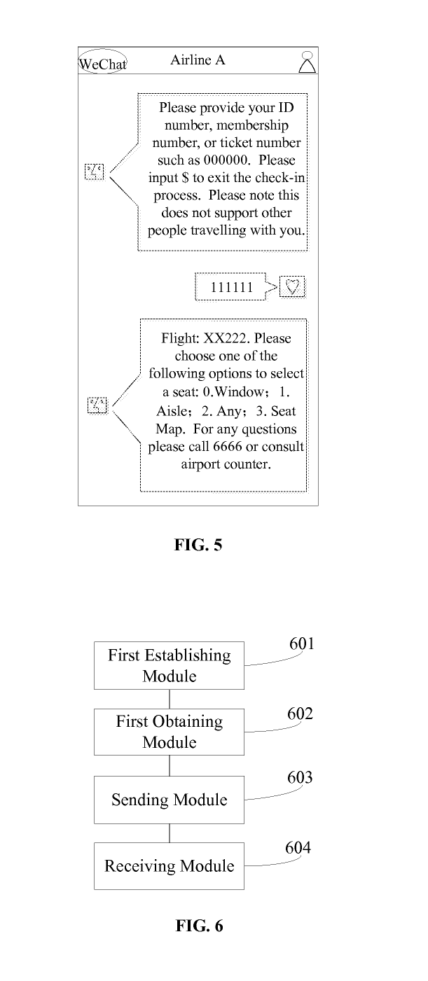

For example, after performing the above-described Steps 304 to 307, according to the guide of the business system server of the airline A, there is a need to continue the information exchange with the business system server of the airline A, Steps 304 to 307 shown in FIG. 5 can be repeatedly performed as desired.

Note that although present disclosure is described using an airline check-in business as an exemplary business for processing, the disclosed methods can be used to process any business including, but not limited to, information consultation business, information inquiry business, service information business for informing, collecting payment, membership binding, and/or other suitable business without limitation.

In various embodiments, in addition to the WeChat backend server, the public service platform can include a SMS backend server, information service platform, and/or other suitable service platforms without any limitation. Further, in addition to the business system server, the third party service provider can include an inquiry server, an information server, and/or any suitable servers without limitation. Furthermore, in addition to the third party service provider for airlines, the third party service provider can be a third party service provider for any other suitable enterprises as desired.

Regardless of what company that the third party service provider is, the business processing can be performed by obtaining authorization from WeChat and using WeChat authorized public platform API (Application Programming Interface) interfaces to combine with API interfaces for secondary developments according to their business needs to achieve communication with the terminal of business processing via the WeChat backend server.

The disclosed methods may establish a connection between the terminal and the business system via the WeChat backend server, such that information exchange can be performed between the terminal and the business system for the business processing. The business processing can be a processing with enhanced convenience, mobility, and real-time operability. Efficiency for the business processing can be improved.

FIG. 6 provides an exemplary terminal for business processing. The exemplary terminal can be used to perform various methods for business processing. The exemplary terminal can include a first establishing module 601, a first obtaining module 602, a sending module 603, and/or a receiving module 604.

The first establishing module 601 can be configured to establish a connection with the third party service provide via a public service platform. The first obtaining module 602 can be configured to obtain a business processing request. The sending module 603 can be configured to send the business processing request to a third party service provider via the public service platform. The receiving module 604 can be configured to receive a business processing response returned from the third party service provider and forwarded by the public service platform to complete the business processing.

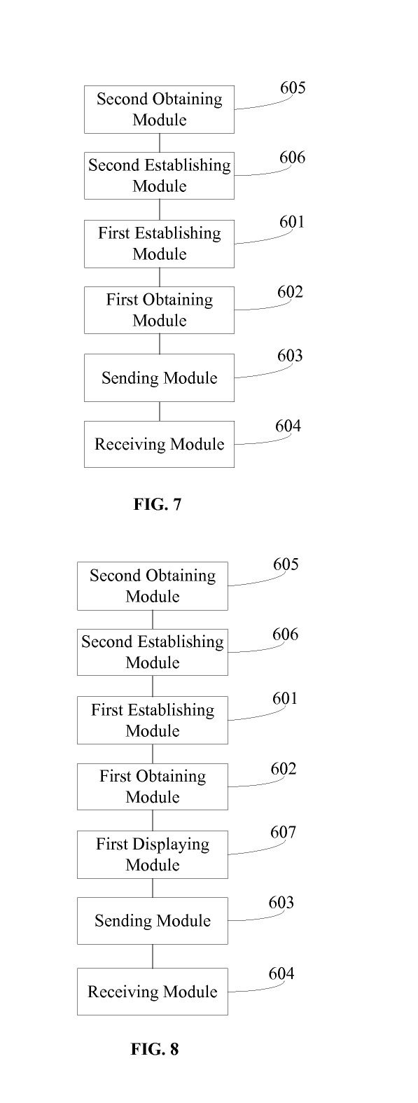

Referring to FIG. 7, the exemplary terminal can further include a second obtaining module 605, and/or a second establishing module 606. The second obtaining module 605 can be configured to obtain a public number of the third party service provider. The second establishing module 606 can be configured to establish a dialogue relationship with the third party service provider corresponding to the public number via the public service platform.

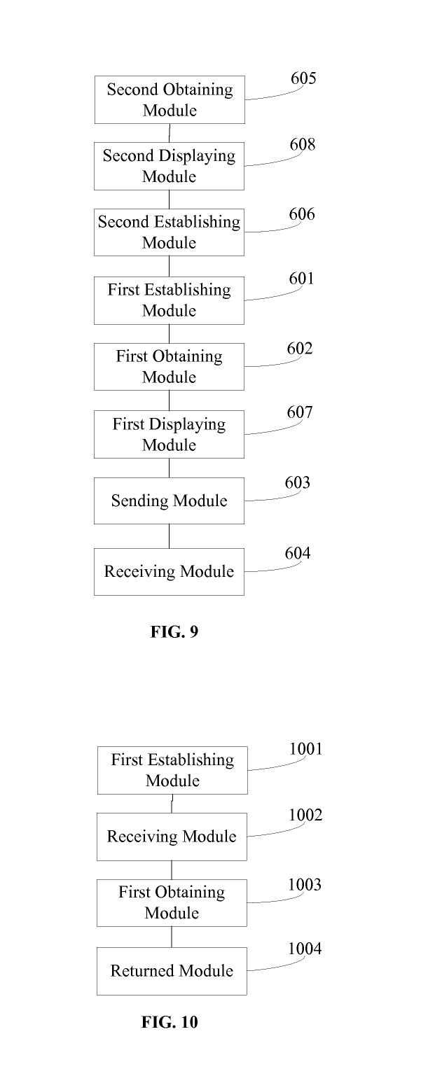

Referring to FIG. 8, the exemplary terminal can further include a first displaying module 607. The first displaying module 607 can be configured to display request content corresponding to the business processing request. Referring to FIG. 9, the exemplary terminal can further include a second displaying module 608. The second displaying module 608 can be configured to display response content corresponding to the business processing response.

The disclosed terminal can establish a connection with the business system via the public service platform and conduct information exchange with the business system for the business processing. Degree of convenience for business processing can be enhanced and efficiency of business processing can be improved.

FIG. 10 depicts an exemplary third party service provider. The exemplary third party service provider can be used to perform methods for business processing, e.g., as depicted in FIGS. 1-5. The exemplary third party service provider can include a first establishing module 1001, a receiving module 1002, a first obtaining module 1003, and/or a returning module 1004.

The first establishing module 1001 can be configured to establish a connection with a terminal to process business via a public service platform. The receiving module 1002 can be configured to receive a business processing request sent from the terminal and forwarded by the public service platform. The first obtaining module 1003 can be configured to obtain a business processing response according to the business processing request. The returning module 1004 can be configured to return the business processing response to the terminal via the public service platform to complete the business processing.

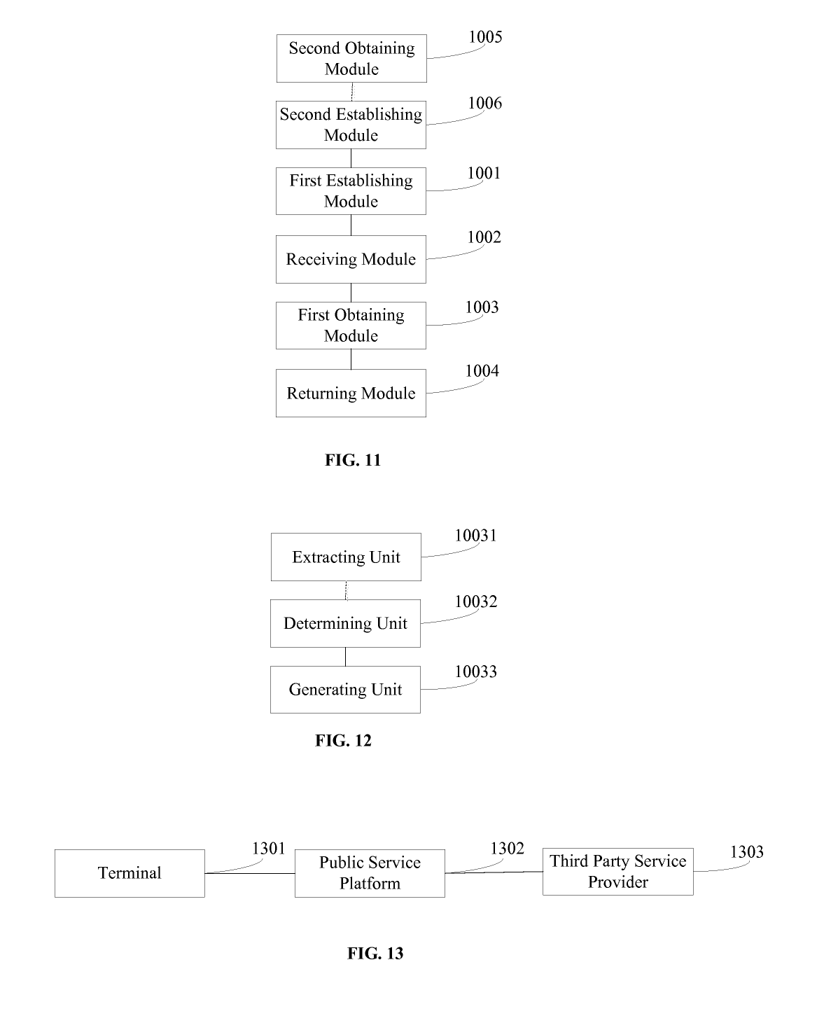

Referring to FIG. 11, the exemplary third party service provider can further include a second obtaining module 1005, and/or a second establishing module 1006.

The second obtaining module 1005 can be configured to obtain ID corresponding to the terminal. The terminal ID can be bound with information used for a user to login the public service platform. The second establishing module 1006 can be configured to establish a dialogue relationship between the terminal ID and the terminal via the public service platform.

Referring to FIG. 12, the first obtaining module 1003 can include an extracting unit 10031, a determining unit 10032, and/or a generating unit 10033. The extracting unit 10031 can be configured to extract request content corresponding to the business processing request. The determining unit 10032 can be configured to determine response content according to the request content corresponding to the business processing request. The generating unit 10033 can be configured to generate the business processing response according to the response content.

The third party service provider disclosed herein can establish a connection with the terminal via the public service platform and perform information exchange with the terminal to complete business processing to enhance convenience, mobility, and real-time operability of business processing with increased efficiency.

FIG. 13 depicts an exemplary business processing system. The exemplary system can be used to perform methods for business processing, e.g., as depicted in FIGS. 1-5. The exemplary system can include a terminal 1301, a public service platform 1302, and/or a third party service provider 1303.

The terminal 1301 can be any terminal as depicted in FIGS. 6-9. The public service platform 1302 can be configured to forward information between the terminal 1301 and the third party service provider 1303. The third party service provider 1303 can be any third party service provider as depicted in FIGS. 10-12.

The disclosed system can establish a connection between the terminal and the business system via the public service platform and perform information exchange between the terminal and the business system to complete the business processing to enhance convenience, mobility, and real-time operability of business processing with increased efficiency.

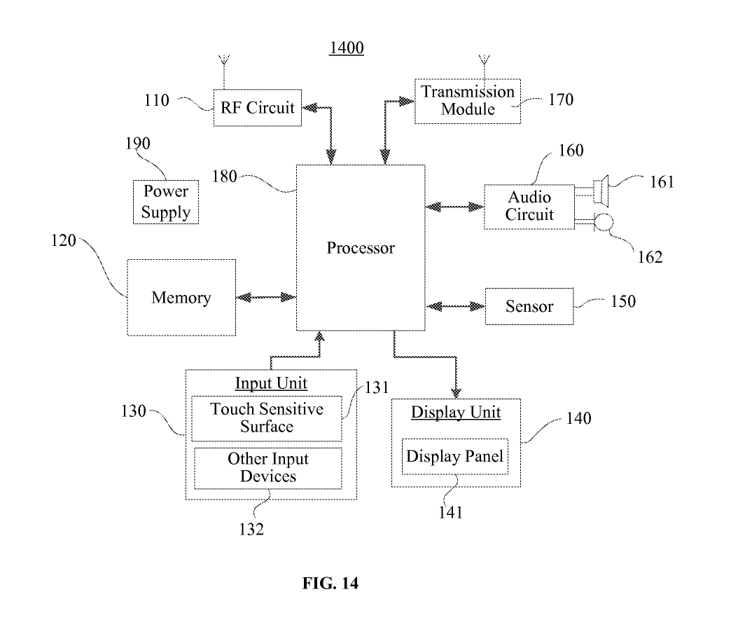

FIG. 14 depicts another exemplary terminal, e.g., a terminal having a touch-sensitive surface. The exemplary terminal 1400 can include an RF (Radio Frequency) circuit 110, a memory 120 including one or more computer-readable storage media, an input unit 130, a display unit 140, a sensor 150, an audio circuit 160, a transmission module 170, a processor 180 including one or more processing cores, a power supply 190, and/or other components. In various embodiments, the terminal(s) described herein can include more or less components as depicted in FIG. 14. Certain parts can be omitted, combined, re-placed, and added.

The RF circuitry 110 may be used to send and receive information or send and receive signal during communication. In particular, after receiving downlink information from a base station, such information can be processed by the one or more processors 180. Further, the data related to the uplink can be sent to the base station. Generally, the RF circuit 110 can include, but be not limited to, an antenna, at least one amplifier, a tuner, one or more oscillators, user identity module (SIM) card, a transceiver, a coupler, LNA (i.e., Low Noise Amplifier), duplexer, etc. In addition, the RF circuitry 110 may communicate with other devices via a wireless communication network. The wireless communication may use any communication standards or protocols, including but not limited to, GSM (Global System for Mobile Communications), GPRS (General Packet Radio Service), CDMA (Code Division Multiple Access), WCDMA (Wideband Code Division Multiple Access), LTE (Long Term Evolution), e-mail, SMS (Short Messaging Service), etc.

The memory 120 can be used for storing software programs and modules, such as those software programs and modules corresponding to the terminal and the third party service provider as described in FIGS. 3-5 for business processing. By running software programs and modules stored in the memory 120, the processor 180 can perform various functional applications and data processing to achieve business processing. The memory 120 can include a program storage area and a data storage area. The program storage area can store the operating system, applications (such as sound playback, image playback, etc.) required by at least one function. The data storage area can store data (such as audio data, phone book, etc.) created when using the terminal 1400. In addition, the memory 120 may include a high-speed random access memory, a non-volatile memory, such as at least one disk memory, flash memory, and/or other volatile solid-state memory elements. Accordingly, the memory 120 may further include a memory controller to provide the processor 180 and the input unit 130 with access to the memory 120.

The input unit 130 can be used to receive inputted numeric or character information, and to generate signal input of keyboard, mouse, joystick, and trackball or optical signal input related to the user settings and function controls. Specifically, the input unit 130 may include a touch sensitive surface 131 and other input device(s) 132. The touch-sensitive surface 131, also known as a touch screen or touch panel, may collect touch operations that a user conducts on or near the touch-sensitive surface 131. For example, a user may use a finger, a stylus, and any other suitable object or attachment on the touch-sensitive surface 131 or on an area near the touch-sensitive surface 131. The touch-sensitive surface 131 may drive a connecting device based on a preset program. Optionally, the touch sensitive surface 131 may include a touch detection device and a touch controller. The touch detection device can detect user's touch position and detect a signal due to a touch operation and send the signal to the touch controller. The touch controller can receive touch information from the touch detection device, convert the touch information into contact coordinates to send to the processor 180, and receive commands sent from the processor 180 to execute. Furthermore, the touch sensitive surface 131 can be realized by resistive, capacitive, infrared surface acoustic wave, and/or other types of surface touch. In addition to the touch sensitive surface 131, the input unit 130 may also include other input device(s) 132. Specifically, the other input device(s) 132 may include, but be not limited to, a physical keyboard, function keys (such as volume control buttons, switch buttons, etc.), a trackball, a mouse, an operating lever, or combinations thereof.

The display unit 140 can be used to display information inputted by the user, information provided to the user, and a variety of graphical user interfaces of the terminal 1400. These graphical user interfaces can be formed by images, text, icons, videos, and/or any combinations thereof. The display unit 140 may include a display panel 141 configured by, e.g., LCD (Liquid Crystal Display), OLED (Organic Light-Emitting Diode), etc. Further, the touch sensitive surface 131 may cover the display panel 141. When the touch sensitive surface 131 detects a touch operation on or near the touch sensitive surface, the touch operation can be sent to the processor 180 to determine a type of the touch operation. Accordingly, the processor 180 can provide visual output on the display panel 141. Although in FIG. 14 the touch-sensitive surface 131 and the display panel 141 are shown as two separate components to achieve input and output functions, in some embodiments, the touch sensitive surface 131 and the display panel 141 can be integrated to perform input and output functions.

The terminal 1400 may further include at least one sensor 150, such as optical sensors, motion sensors, and other suitable sensors. Specifically, the optical sensors may include an ambient optical sensor and a proximity sensor. The ambient optical sensor may adjust brightness of the display panel 141 according to the brightness of ambient light. The proximity sensor can turn off the display panel 141 and/or turn backlighting, when the terminal 1400 moves to an ear. As a type of motion sensor, a gravity sensor may detect amount of an acceleration in each direction (e.g., including three axis) and detect magnitude and direction of gravity when in stationary. The gravity sensor can be used to identify phone posture (for example, switching between horizontal and vertical screens, related games, magnetometer calibration posture, etc.), vibration recognition related functions (e.g., pedometer, percussion, etc.), etc. The terminal 1400 can also be configured with, e.g., a gyroscope, a barometer, a hygrometer, a thermometer, an infrared sensor, and/or other sensors.

The audio circuit 160, the speaker 161, and the microphone 162 may provide an audio interface between the user and terminal 1400. The audio circuit 160 may transmit an electrical signal converted from the received audio data to the speaker 161 to convert into audio signal output. On the other hand, the microphone 162 can convert the collected sound signal to an electrical signal, which can be received by the audio circuit 160 to convert into audio data. The audio data can be output to the processor 180 for processing and then use the RF circuit 110 to transmit to, e.g., another terminal. Alternatively, the audio data can be output to the memory 120 for further processing. The audio circuitry 160 may also include an earplug jack to provide communications between the peripheral headset and the terminal 1400.

The terminal 1400 may use the transmission module 170 to help users send and receive emails, browse websites, access streaming media, etc. The transmission module 170 can provide users with a wireless or wired broadband Internet access. In various embodiments, the transport module 170 can be configured within or outside of the terminal 1400 as depicted in FIG. 14.

The processor 180 can be a control center of the terminal 1400: using a variety of interfaces and circuits to connect various parts, e.g., throughout a mobile phone; running or executing software programs and/or modules stored in the memory 120; calling the stored data in the memory 120; and/or performing various functions and data processing of the terminal 1400 to monitor the overall mobile phone. Optionally, the processor 180 may include one or more processing cores. In an exemplary embodiment, the processor 180 may integrate application processor with modulation and demodulation processor. The application processor is mainly used to process operating system, user interface, and applications. The modulation and demodulation processor is mainly used to deal with wireless communications. In various embodiments, the modulation and demodulation processor may or may not be integrated into the processor 180.

The terminal 1400 may further include a power supply 190 (such as a battery) to power various components of the terminal. In an exemplary embodiment, the power supply can be connected to the processor 180 via the power management system, and thus use the power management system to manage charging, discharging, and/or power management functions. The power supply 190 may also include one or more DC or AC power supplies, a recharging system, a power failure detection circuit, a power converter or inverter, a power status indicator and/or any other suitable components.

Although not shown in FIG. 14, the terminal 1400 can further include a camera, a Bluetooth module, etc. without limitation. Specifically, the terminal can have a display unit of a touch screen display, a memory, and one or more programs stored in the memory. The terminal can be configured to use one or more processor to execute the one or more programs stored in the memory. The execution (e.g., may be referred to as a first execution) may include following operational commands: to establish a connection with a third party service provider via a public service platform and to obtain a business processing request; to send the business processing request to the third party service provider via the public service platform; and to receive a business processing response returned from the third party service provider and forwarded by the public service platform for a business processing.

In another exemplary execution in a memory of the terminal, based on the above-described first execution, operational commands can further include obtaining a public number of the third party service provider, using the public service platform to establish a dialogue relationship with a third party service provider corresponding to the public number. In still another exemplary execution in a memory of the terminal, based on the above-described first execution, operational commands can further include displaying request content corresponding to the business processing request. In yet another exemplary execution in a memory of the terminal, based on the above-described first execution, operational commands can further include displaying response content corresponding to the business processing response.

In this manner, the disclosed terminal may use the public service platform to establish a connection with a business system and perform information exchange with the business system to perform the business processing to enhance convenience, mobility, and real-time operability of business processing with increased efficiency.

Various embodiments also provide a computer-readable storage medium. The computer-readable storage medium may be a computer-readable storage medium contained in the above-described memory (e.g., as depicted in FIG. 14). The computer-readable storage medium can be separately configured, e.g., in a computer-readable storage medium in the terminal. The computer-readable storage medium can store one or more programs used by one or more processors to execute a business processing in an exemplary method.

In a first exemplary method, a connection can be established with the third party service provider via the public service platform and a business processing request can be obtained. The business processing request can be sent to the third party service provider via the public service platform. A business processing response can be received from the third party service provider and forwarded by the public service platform to complete the business processing.

Based on the first exemplary method, another exemplary method can be provided. In this method, a public number of the third party service provider can be obtained. A dialogue relationship can be established with the third party service provider corresponding to the public number via the public service platform. Based on the first exemplary method, still another exemplary method can be provided. In this method, request content corresponding to the business processing request can be displayed. Based on the first exemplary method, yet another exemplary method can be provided. In this method, response content corresponding to the business processing response can be displayed.

The disclosed computer-readable storage medium can use the public service platform to establish a connection between the terminal and the business system to perform information exchange between the terminal and the business system to perform the business processing to enhance convenience, mobility, and real-time operability of business processing with increased efficiency.

Various embodiments provide an exemplary graphical user interface. The exemplary graphical user interface can be used in the terminal, e.g., as depicted in FIG. 14. The terminal includes a touch screen display, a memory, and one or more processors for executing one or more programs. The exemplary graphical user interface can be used as the following. A connection can be established with the third party service provider via the public service platform and a business processing request can be obtained. The business processing request can be sent to the third party service provider via the public service platform. A business processing response can be received from the third party service provider and forwarded by the public service platform to complete the business processing.

The disclosed graphical user interface can use the public service platform to establish a connection between the terminal and the business system to perform information exchange between the terminal and the business system to perform the business processing to enhance convenience, mobility, and real-time operability of business processing with increased efficiency.

It should be noted that, when use the terminal, the public service platform, and/or the third party service provider to perform a business processing, the above-described function modules/units can be configured in any suitable manners to partially or wholly perform desired function(s). For example, the modules/units can be configured in one device or in multiple devices as desired. The modules/units disclosed herein can be integrated in one module or in multiple modules. Each of the modules/units disclosed herein can be divided into one or more sub-modules, which can be recombined in any manners.

The disclosed embodiments can be examples only. One of ordinary skill in the art would appreciate that suitable software and/or hardware (e.g., a universal hardware platform) may be included and used to perform the disclosed methods. For example, the disclosed embodiments can be implemented by hardware only, which alternatively can be implemented by software products only. The software products can include suitable commands to enable a terminal (e.g., including a mobile phone, a personal computer, or a network device, etc.) to implement the disclosed embodiments.

Other applications, advantages, alternations, modifications, or equivalents to the disclosed embodiments are obvious to those skilled in the art and are intended to be encompassed within the scope of the present disclosure.

Various embodiments provide methods, apparatus (e.g., terminals and/or servers), and systems for business processing. An exemplary business processing method for a user terminal can be performed by establishing a connection between the user terminal and a first server for providing a third-party service via a second server for providing a public service. A business processing request can be obtained by the user terminal, which can then send the business processing request to the first server for providing the third party service via the second server for providing the public service. The first server for providing the third party service can include a business system server. Corresponding to the business processing request, the user terminal can receive a business processing response returned from the first server for providing the third-party service and forwarded by the second server for providing the public service. Another exemplary method for a server for providing a third party service can be provided in accordance with various disclosed embodiments.

Various embodiments further provide a user terminal for business processing, a server for providing a third party service, and/or a system for business processing. An exemplary user terminal can include a first establishing module, a first obtaining module, a sending module, and a receiving module. An exemplary server for providing a third party service can include a first establishing module, a receiving module, a first obtaining module, and a returning module. An exemplary system for business processing can include a first server for providing a third party service, a user terminal, and/or a second server for providing a public service. The second server for providing the public service can be configured to forward information between the user terminal and the first server for providing the third party service.

As disclosed herein, by establishing a connection between a first server for providing a third party service (e.g., a business system) and a second server for providing a public service (e.g., a public service platform), the second server for providing the public service can connect a user terminal with the first server for providing the third party service (e.g., the business system) such that information exchange can be performed between the user terminal and the first server for providing the third party service (e.g., the business system). This enhances convenience, mobility, and real-time operability of the business processing with improved efficiency.

What is claimed is:

1. A business processing method for a user terminal, comprising:
establishing a connection between the user terminal and a first server for providing a third-party service via a second server for providing a public service;
obtaining, by the user terminal, a business processing request;
sending, by the user terminal, the business processing request to the first server for providing the third party service via the second server for providing the public service, wherein the first server for providing the third party service comprises a business system server; and
receiving, by the user terminal, a business processing response returned from the first server for providing the third-party service and forwarded by the second server for providing the public service corresponding to the business processing request.

2. The method of claim 1, wherein, before establishing the connection between the user terminal and the first server for providing the third party service, the method further comprises:
obtaining, by the user terminal, a public number of the first server for providing the third party service; and
using the second server for providing the public service to establish a dialogue relationship between the user terminal and the first server for providing the third party service corresponding to the public number.

3. The method of claim 1, wherein, after obtaining the business processing request by the user terminal, the method further comprises: displaying request content corresponding to the business processing request on the user terminal.

4. The method of claim 1, wherein, after receiving the business processing response by the user terminal, the method further comprises: displaying response content corresponding to the business processing response on the user terminal.

5. A business processing method for a server for providing a third party service, comprising:
establishing a connection between a first server for providing a third party service and a user terminal for a business processing via a second server for providing a public service;
receiving, by the first server for providing the third party service, a business processing request sent from the user terminal and forwarded by the second server for providing the public service;
according to the business processing request, obtaining, by the first server for providing the third party service, a business processing response corresponding to the business processing request; and
returning, by the first server for providing the third party service, the business processing response to the user terminal via the second server for providing the public service.

6. The method of claim 5, wherein, before establishing the connection between the first server for providing the third party service and the user terminal, the method further comprises:
obtaining an ID corresponding to the user terminal, wherein the ID corresponding to the user terminal is bound with information used for a user to login the second server for providing the public service; and
using the second server for providing the public service to establish a dialogue relationship between the ID corresponding to the user terminal and the user terminal.

7. The method of claim 5, wherein, according to the business processing request, obtaining the business processing response by the first server for providing the third party service comprises:
extracting request content corresponding to the business processing request;
determining response content corresponding to the request content corresponding to the business processing request; and
generating the business processing response according the response content.

8. A user terminal for business processing, comprising:
a first establishing module, configured to establish a connection between the user terminal and a first server for providing a third party service via a second server for providing a public service;
a first obtaining module, configured to obtain a business processing request;
a sending module, configured to send the business processing request to the first server for providing the third party service via the second server for providing the public service; and
a receiving module, configured to receive a business processing response returned from the first server for providing the third party service and forwarded by the second server for providing the public service according to the business processing request.

9. The terminal of claim 8, further comprising:
a second obtaining module, configured to obtain a public number of the first server for providing the third party service; and
a second establishing module, configured to establish a dialogue relationship between the user terminal and the first server for providing the third party service corresponding to the public number via the second server for providing the public service.

10. The terminal of claim 8, further comprising:
a first displaying module, configured to display request content corresponding to the business processing request on the user terminal.

11. The terminal of claim 8, further comprising:
a second displaying module, configured to display response content corresponding to the business processing response on the user terminal.

12. A server for providing a third party service, comprising:
a first establishing module, configured to establish a connection between the server for providing the third party service and a user terminal for a business processing via a server for providing a public service;
a receiving module, configured to receive a business processing request sent from the user terminal and forwarded by the server for providing the public service;
a first obtaining module, configured to obtain a business processing response according to the business processing request; and
a returning module, configured to return the business processing response corresponding to the business processing request to the user terminal via the server for providing the public service.

13. The server of claim 12, further comprising:
a second obtaining module, configured to obtain an ID corresponding to the user terminal, wherein the ID corresponding to the user terminal is bound with information used for a user to login the server for providing the public service; and
a second establishing module, configured to establish a dialogue relationship between the ID corresponding to the user terminal and the user terminal via the server for providing the public service.

14. The server of claim 12, wherein the first obtaining module comprises:
an extracting unit, configured to extract request content corresponding to the business processing request;
a determining unit, configured to determine response content according to the request content corresponding to the business processing request; and
a generating unit, configured to generate the business processing response according to the response content.

15. A system comprising the server for providing the third party service of claim 14,
wherein the system further comprises a user terminal and a server for providing a public service, and wherein the server for providing the public service is configured to forward information between the user terminal and the server for providing the third party service.

16. A system comprising the user terminal of any one of claim 8,
wherein the system further comprises a first server for providing a third party service and a second server for providing a public service, and wherein the second server for providing the public service is configured to forward information between the user terminal and the first server for providing the third party service.
